(19) United States
(12) Patent Application Publication
(10) Pub. No.: US 2021/0198589 A1
(43) Pub. Date: Jul. 1, 2021

(54) Solid Fire Started and Preparation Method Thereof

(71) Applicant: Tim Noh, (US)

(72) Inventor: Hyo Sun Hong, Nonsan-si (KR)

(21) Appl. No.: 16/727,344

(22) Filed: Dec. 26, 2019

(51) Int. Cl. C10L 5/44; C10L 9/10; C10L 5/36

(52) U.S. Cl. CPC C10L 5/445; C10L 9/10; C10L 2290/22; C10L 2200/0469; C10L 5/36

(57) ABSTRACT

Solid fuel starter, including its manufacturing method, that utilizes agricultural biomass that displays high level of absorbency is provided. The anatomy of the typical biomass material, like corn cob, consists of several segments: a pith portion which includes a sponge like tissue infiltrated with a heating agent; a woody ring portion which surrounds an outer circumferential surface of the pith portion and maintains the rigidity of a body of the rapid flame starter; and a chaff portion which extends from the woody ring portion and includes an amorphous mane-like shell formed thereon. With an appropriate manufacturing technique, this type of agricultural biomass can be transformed into an efficient and rapid flame starter.

### BACKGROUND

### 1. Field of the Invention

The present invention relates to a solid fire starter that is easy to ignite and exhibits a high heating value and preparation method thereof.

### 2. Discussion of Related Art

Solid fuel is commonly used as a heat source for cooking foods such as meat roasting or the like or as a heat source for heating.

A majority of such solid fuels are produced from waste such as agricultural waste, forestry waste, mining waste or the like. However, solid fuels made out of materials such as firewood, charcoal briquettes or the like are difficult to ignite on their own and require ignition fuels such as a compact gas-burning flamethrower or liquid gasoline or the like.

These ignition fuels are very difficult to store and transport, and are also flammable. Additionally, not only is the ignition of solid fuels time consuming, but also the fumes generated as a byproduct of incomplete combustion are very harmful to the human body.

Biomass is an organic material that comes from an organism such as a plant or microorganism and used as an energy source. Some plant derived biomass, such as lignum sawdust, are compacted to make solid fuels in the form of wood chips or pellets. However, manufacturing the solid fuels into these compact forms are complex. Due to having a very low heating value per unit weight or volume compared to other forms of biomass, such solid fuels require an increased amount or volume of raw materials to produce the same heating value. In addition, in the case of the wood-derived biomass, there is the problem that it takes a long time until enough wood is obtained.

Meanwhile, as a plant for food as well as feed, the production of corn has greatly increased. A corncob, which is a waste product of corn, is usually discarded. The disposal issues have caused many problems with the annually increasing corncob waste. Therefore, there is an urgent need to develop a new recycling technique capable of utilizing the waste product being discarded.

### PRIOR-ART DOCUMENTS

### Patent Documents

(Patent Document 0001) US20080171297A1

### SUMMARY OF THE INVENTION

The present invention is directed to providing a solid fire starter which is prepared using discarded corncobs that cannot be used in agriculture, and is easily ignited and completely combusted.

However, the objective of the present invention is not limited to the objective described above, and other objectives not described above will be clearly understood by those skilled in the art from the following description.

In order to achieve the objective, one aspect of the present invention provides a solid fire starter prepared using a porous plant tissue. The porous plant anatomy consists of several segments: a pith portion which includes a porous tissue infiltrated with a heating agent; a woody ring portion which surrounds an outer circumferential surface of the pith portion and maintains the rigidity of a body of the solid fire starter; and a chaff portion which extends from the woody ring portion and includes an amorphous mane-like shell formed thereon. The porous tissue may be derived from any one corn part selected from the group consisting of a corncob and the corn stalk. The heating agent may be any one of the C1-C4 alcohols. When the heating agent is ethanol, it may have a concentration of 95% or more. The solid fire starter may have a lower heating value of 3,540 kcal/kg or more.

Another aspect of the present invention provides a method of preparing a solid fire starter using a corncob, which includes the steps of: (a) providing a fuel body and an immersion bath; (b) filling the immersion bath with a heating agent and immersing the fuel body therein; (c) sealing the immersion bath and then allowing the heating agent to infiltrate into the fuel body using a vacuum pump; and (d) centrifuging the fuel body infiltrated with the heating agent, thereby allowing a heating agent residue on a surface of the fuel body to be removed. In step (a), the fuel body may be any part of the corn: the corncob or the corn stalk, and may include a porous tissue.

Naturally dried after fruits have been removed therefrom, the fuel body may have a water content of 10 to 15%. In step (b), the heating agent may be any one of the C1-C4 alcohols. When the heating agent is ethanol, it may have a concentration of 95% or more. In step (c), the immersion bath is sealed and a negative pressure of 100 kPa/1 kg to 3 kPa/1 kg is maintained for 30 to 60 minutes using a vacuum pump, which allows the heating agent to infiltrate into the fuel body. In step (d), the fuel body is centrifuged at 1,000 to 3,000 rpm for one to five minutes, which allows a heating agent residue to be removed from the surface of the fuel body.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a photographic image showing a planar cross-sectional view of a solid fire starter prepared using a corncob according to one exemplary embodiment of the present invention.

FIG. 2 is a process flow diagram illustrating the sequence of processes performed in the method of preparing a solid fire starter using a corncob according to one exemplary embodiment of the present invention.

FIG. 3 is a schematic diagram illustrating the configuration required for processes performed in the method of preparing a solid fire starter using a corncob according to one exemplary embodiment of the present invention.

FIG. 4 shows scanning electron microscope images of a corncob according to one exemplary embodiment of the present invention.

FIG. 5 shows enlarged photographic images of a pith portion of a solid fire starter prepared using a corncob according to one exemplary embodiment of the present invention, which includes the corncob.

FIG. 6 illustrates the results of evaluating a heating value of a solid fire starter prepared using a corncob according to one exemplary embodiment of the present invention.

FIG. 7 shows photographic images illustrating the evaluation of ignition time of a solid fire starter prepared using a corncob according to one exemplary embodiment of the present invention.

FIG. 8 shows photographic images illustrating the evaluation of an ignition efficiency of a solid fire starter prepared using a corncob according to one exemplary embodiment of the present invention.

### DETAILED DESCRIPTION OF EXEMPLARY EMBODIMENTS

Hereinafter, some exemplary embodiments of the present invention will be described in detail with reference to the accompanying drawings.

Advantages and features of the present invention and methods for achieving the same will be apparent by the exemplary embodiments described below in detail with reference to the accompanying drawings.

However, the present invention is not limited to the exemplary embodiments described below and may be implemented in various d forms. Rather, the exemplary embodiments have been provided to make the disclosure of the present invention thorough and complete and to fully inform the scope of the present invention to those of ordinary skill in the art to which the present invention pertains, and the present invention is defined only by the scope of the claims.

In addition, in describing the present invention, when it is determined that a description of a known technique related to the present invention and the like may unnecessarily obscure the gist of the present invention, the detailed description will be omitted.

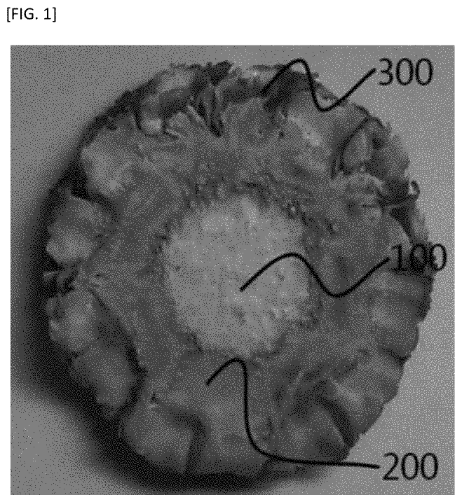

FIG. 1 is a photographic image showing a planar cross-sectional view of a solid fire starter prepared using a corncob according to one exemplary embodiment of the present invention.

Referring to FIG. 1, the solid fire starter prepared using a corncob according to the present invention includes a pith portion 100, a woody ring portion 200, and a chaff portion 300.

The pith portion 100 is formed of a porous tissue, and, due to the infiltration of a heating agent thereinto, the pith portion 100 is easily ignited and is combustible for a long time, thus allowing the solid fire starter to be completely combusted.

The porous tissue may be derived from any one corn part selected from the group consisting of a corncob and a corn stalk.

Any corn including a porous tissue may be used, and particularly since genetically modified plants also include a porous tissue, there is the advantage that crop-derived waste products with limited recyclability can be utilized.

Since the corn has a certain length, cutting the same into halves or thirds to prepare a solid fire starter provides the advantage of convenience in storage and transportation, but the present invention is not limited thereto.

The heating agent may be any one of C1-C4 alcohols.

When the heating agent is selected from among the alcohols, various oxides harmful to the human body are not emitted during combustion while a heating value equivalent to that of gasoline or kerosene used as a conventional ignition agent or heating agent is exhibited. Therefore, the solid fire starter is usable not only as a solid fire starter for heating but also as a solid fire starter for cooking foods, such as roasting.

In addition, when added, the heating agent allows the solid fire starter to continue to combust even after the ignited fire has been put out, so that the solid fire starter is completely combusted.

When the heating agent is ethanol, it may have a concentration of 95% or more.

When the concentration of the ethanol is less than 95%, the amount of heat produced during the combustion of the solid fire starter may be decreased, ethanol may not sufficiently infiltrate into the pith portion 100, and physical properties such as a heating value of the solid fire starter may be degraded after long-term storage of the solid fire starter.

The solid fire starter may have a lower heating value of 3,540 kcal/kg or more.

Whereas lignum-based solid fire starters generally have a lower heating value of 3,400 kcal/kg, the solid fire starter including a porous tissue infiltrated with a heating agent has a very high lower heating value of 3,540 kcal/kg, and thus is a very highly efficient solid fire starter.

When the solid fire starter has a lower heating value of 3,540 kcal/kg or more, it is usable not only as a solid fire starter for cooking foods but also as a solid fire starter for heating.

The woody ring portion 200 surrounds an outer circumferential surface of the pith portion 100 and maintains the rigidity of the body of the solid fire starter.

The majority of the woody ring portion 200 consists of cell walls which harden the plant tissue, and the woody ring portion 200 has smaller pores than those of the pith portion 100.

When the heating agent infiltrates through the woody ring portion 200, since the heating agent can remain in the pith portion 100 for a long time, the physical properties of the solid fire starter can be improved.

The chaff portion 300 may extend from the woody ring portion 200, and may include an amorphous mane-like shell formed thereon.

The chaff portion 300 is a portion that remains after fruits such as corn kernels have been removed, and includes an irregular mane-like shape.

The formation of the chaff portion 300 provides the advantage of making the solid fire starter to be easily ignited at first ignition.

Another aspect of the present invention provides a method of preparing a solid fire starter using a corncob.

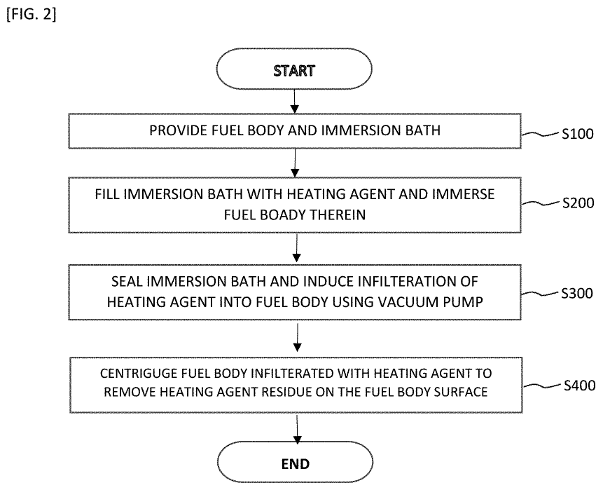

FIG. 2 is a process flow diagram illustrating the sequence of processes performed in a method of preparing a solid fire starter using a corncob according to one exemplary embodiment of the present invention.

Referring to FIG. 2, the method of preparing a solid fire starter using a corncob includes the steps of: (a) providing a fuel body and an immersion bath; (b) filling the immersion bath with a heating agent and immersing the fuel body therein; (c) sealing the immersion bath and then allowing the heating agent to infiltrate into the fuel body using a vacuum pump; and (d) centrifuging the fuel body infiltrated with the heating agent, thereby allowing a heating agent residue on a surface of the fuel body to be removed.

The fuel body may be any one corn part selected from the group consisting of a corncob and a corn stalk, and may include a porous tissue.

Unlike in the case where lignum is used as the fuel body and thus operations of grinding and processing the lignum at high temperature and high pressure are essential, when one selected from among the above-described corn parts is used as the fuel body, there is the advantage that crop-derived waste products can be utilized without further processing.

In particular, although corn is largely used not only as a food crop but also as a feed crop, the utility of corncobs excluding corn kernels is limited. Therefore, the method of preparing a solid fire starter using such a corncob as a fuel body allows solid fire starter manufacturing costs to be reduced because crop-derived waste products being discarded are utilized, and very high process efficiency is exhibited because operations such as grinding and pressurizing are not required.

When naturally dried after corn kernels have been removed therefrom, the corncob may have a water content of 10 to 15%.

When the water content is less than 10%, production efficiency is lowered because more time is consumed in drying corncob, and when the water content exceeds 15%, it is difficult for the heating agent to infiltrate into the fuel body, and a heating value of the solid fire starter may be lowered.

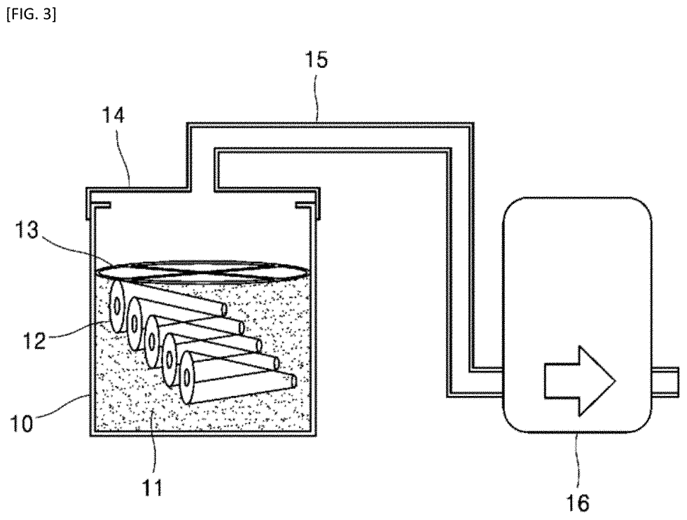

FIG. 3 is a schematic diagram illustrating the configuration required for processes performed in a method of preparing a solid fire starter using a corncob according to one exemplary embodiment of the present invention.

Referring to FIG. 3, an immersion bath 10 provides a space in which the heating agent 11 can be accommodated.

The size of the immersion bath 10 may vary depending on the size and number of the fuel body 12.

After the fuel body 12 and the immersion bath 10 are provided (S100), the immersion bath 10 may be filled with the heating agent 11, and the fuel body 12 may be immersed therein (S200).

Here, the heating agent 11 may be any one of the C1-C4 alcohols.

When such an alcohol is selected, although the solid fire starter has the advantage of having a higher heating value than lignum-based solid fire starters and not emitting various oxides during combustion thereof, there is no limitation for the use of a heating agent as long as the heating agent has a heating value equivalent to that of the alcohol.

When the heating agent 11 is ethanol, it may have a concentration of 95% or more.

Meanwhile, when the fuel body 12 is immersed in the immersion bath 10, operations of placing a wire mesh 13 to prevent the fuel body 12 from floating in the heating agent 11 and then pressing down the fuel body 12 may be further carried out.

The fuel body 12 may be completely submerged by a weight of the wire mesh 13, and when the operation of pressing down the fuel body 12 with the wire mesh 13 is not performed, a problem of the heating agent 11 not sufficiently infiltrating into the fuel body 12 may occur.

After sealing the immersion bath 10, the vacuum pump 16 may be used to allow the heating agent 11 to infiltrate into the fuel body 12 (S300).

The immersion bath 10 may be sealed with a sealing lid 14 after the fuel body 12 is loaded therein, and the vacuum pump 16 can lower the pressure inside the immersion bath 10.

In this case, the vacuum pump 16 may be operated to maintain a negative pressure of 100 kPa/1 kg to 3 kPa/1 kg for 30 to 60 minutes to allow the heating agent 11 to infiltrate into the fuel body 12.

The operation of the vacuum pump 16 causes the air in the immersion bath 10 to flow along a conduit 15 extending from the sealing lid 14 and be discharged to the outside by the vacuum pump 16.

When a negative pressure of 100 kPa/1 kg or less is formed in the immersion bath 10, the heating agent 11 may not sufficiently infiltrate into the fuel body 12, and when a negative pressure of 3 kPa/1 kg or more is formed, process efficiency may be lowered because the energy consumption of the pump is large.

In addition, when the vacuum pump 16 is operated for less than 30 minutes, the air inside the fuel body 12 is not completely removed, making it difficult for the heating agent 11 to infiltrate deeply, and when the vacuum pump 16 is operated for more than 60 minutes, the effect of inducing infiltration of the heating agent 11 is greatly reduced.

The fuel body infiltrated with the heating agent may be centrifuged, which allows a heating agent residue on a surface of the fuel body to be removed (S400).

Due to the inclusion of an amorphous mane-like shell formed thereon, the surface of the fuel body 12 can hold a large amount of a residual heating agent 11.

A large amount of the heating agent 11 remaining on the surface of the fuel body 12 increases the difficulty of packing and storing the fuel body, and therefore, it is required that an operation of removing the heating agent 11 from the surface is carried out.

Since the shell of the surface has a large surface area due to the inclusion of a large number of grooves formed therein, it is highly preferred that the heating agent 11 on the surface is removed through centrifugation than by natural drying.

The centrifugation process may be carried out by centrifuging the fuel body 12 at 1,000 to 3,000 rpm for one to five minutes, causing the heating agent 11 remaining on the surface of the fuel body 12 to be removed.

When the centrifugation rpm is below the above-described range, the heating agent 11 may remain on the surface due to insufficient centrifugation, and when the centrifugation rpm exceeds the above-described range, even the heating agent 11 which has deeply infiltrated into the fuel body 12 may be discharged, causing the heating value of the solid fire starter to be lowered.

The method may further include operations of recovering the heating agent 11 which has been removed from the surface of the solid fire starter through centrifugation and reintroducing the heating agent 11 to the immersion bath 10 after filtering off residues. The recovery and reuse of the heating agent 11 can greatly improve the manufacturing efficiency of the solid fire starter.

Hereinafter, some exemplary embodiments will be provided to facilitate understanding of the present invention, but the following embodiments are merely illustrative of the present invention and are not intended to limit the scope of the present invention thereto.

### Example 1: Preparation of Solid Fire Starter Using a Corncob

Corncobs, which are crop-derived waste products, were collected and naturally dried to a water content of less than 10%.

After the corncobs were immersed in an ethanol-filled immersion bath and pressed down with a wire mesh to prevent them from rising, the immersion bath was sealed, and a vacuum pump connected to one side of the immersion bath was operated for 30 minutes, thereby maintaining a pressure of 5 kPa/1 kg.

Subsequently, the corncobs were collected and centrifuged at 1,000 rpm for one minute to completely remove ethanol remaining on the surface of the corncobs.

### Experimental Example 1: Confirmation of Porosity in Corncob Tissue

In order to use a plant having a porous tissue as a fuel body of a solid fire starter, tissues of a corncob as a candidate for such use were examined to evaluate the porosity thereof.

The microstructure of the corncob was examined at the Advanced Analysis Center of the Korea Institute of Science and Technology, using a scanning electron microscope (XL30 ESEM manufactured by Philips Co., Netherlands).

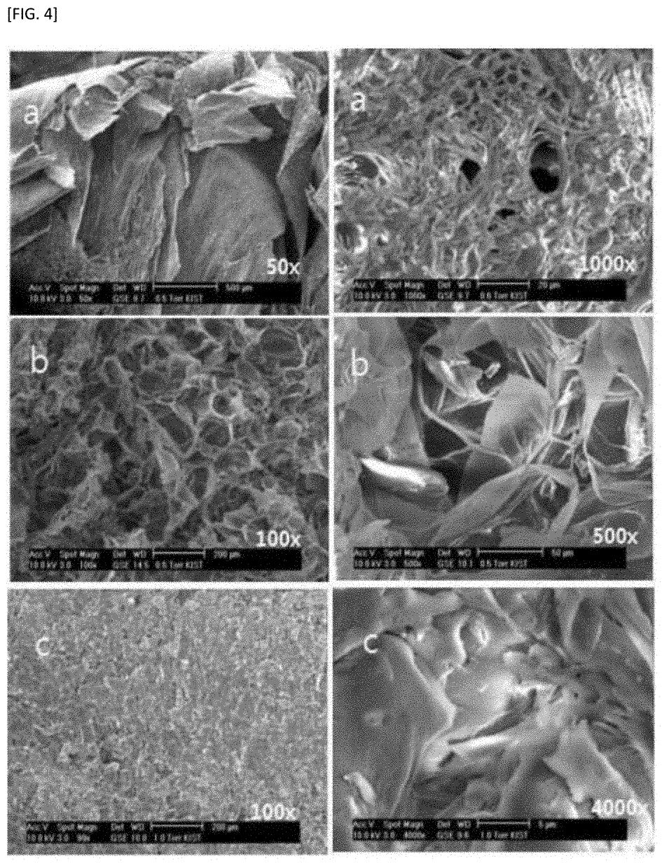

FIG. 4 shows scanning electron microscope images of a corncob according to one exemplary embodiment of the present invention.

FIG. 4 shows (a) a chaff portion at ×50 and ×1,000 magnifications, (b) a pith portion of a fuel body at ×100 and ×500 magnifications, and (c) a woody ring portion at ×100 and ×4,000 magnifications.

Referring to FIG. 4, the corncob was observed to include an outermost chaff portion and a sturdy woody ring portion formed on the inside thereof and, further, a pith portion formed on the inside of the woody ring portion.

In addition, the pith portion was observed to include the formation of a tissue having a large number of pores which may allow the infiltration of ethanol to increase the heating value of the solid fire starter.

In particular, it was observed that the pith portion located in the center included a tissue having a countless number of pores, which confirms that the pith portion is suitable for allowing the infiltration of ethanol which is a heating agent.

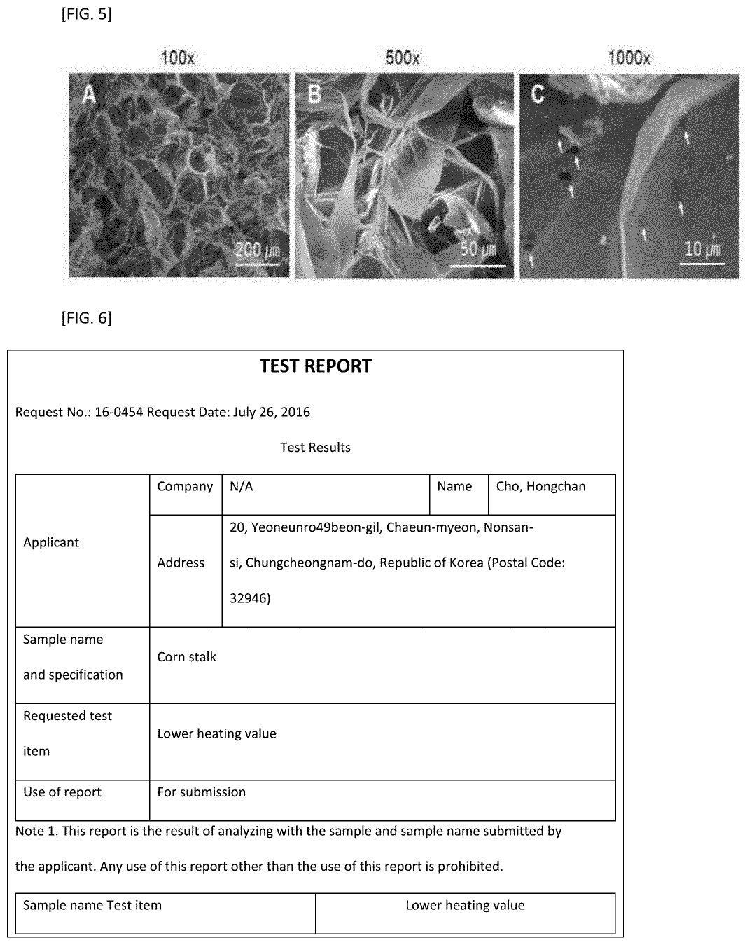

FIG. 5 shows enlarged photographic images of a pith portion of a solid fire starter prepared using a corncob according to one exemplary embodiment of the present invention, which includes a porous tissue.

FIG. 5 shows the pith portion (A) at ×100 magnification, (B) at ×500 magnification, and (C) at ×1,000 magnification.

Referring to FIG. 5A, the pith portion of the corncob was found to have a spongy structure which includes the formation of a plurality of densely populated holes, and referring to FIG. 5B, the spongy structure was found to include numerous spaces which are surrounded by a single layer of a thin membrane and are clustered together while being separated by the membranes.

In addition, according to the 1,000× magnification provided in FIG. 5C, the thin membranes were found to have a plurality of very small holes (2 to 3 μm) that connect the spaces with one another.

Therefore, it was confirmed that the pith portion of a corncob included the formation of a porous tissue, that the infiltration of ethanol should be carried out by allowing the ethanol to infiltrate slowly while removing air in spaces deep inside, and that it will be essential to carry out an operation for preventing the destruction of the thin films during the infiltration.

In addition, since the tissue of the woody ring portion has almost no pores as shown in FIG. 4C, it may be difficult to cause ethanol to infiltrate through the woody ring portion and into the pith portion by a simple immersion method alone, and therefore, it was confirmed that an operation of inducing a negative pressure to allow the ethanol to infiltrate slowly will be necessary.

### Experimental Example 2: Evaluation of Heating Value of Solid Fire Starter

The heating value of the solid fire starter prepared in Example 1 was evaluated.

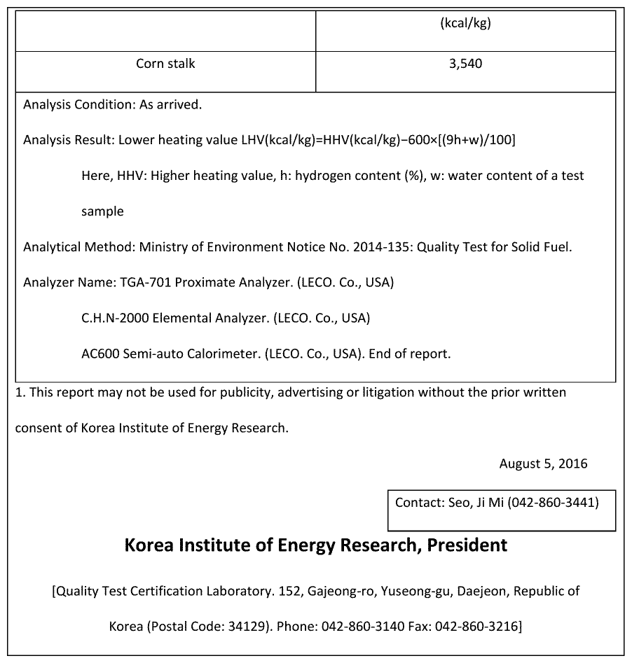

FIG. 6 illustrates the results of evaluating a heating value of a solid fire starter prepared using a porous plant tissue according to one exemplary embodiment of the present invention.

Referring to FIG. 6, in order to evaluate the heating value, a request was made to the Korea Institute of Energy Research to measure lower heating values, where the measurement was carried out by a quality test method for solid fuel products in accordance with the notice of the Ministry of Environment of the Republic of Korea.

Here, a thermogravimetric analyzer (TGA-701 manufactured by LECO. Co., USA), an elemental analyzer (C.H.N-2000 manufactured by LECO. Co., USA), and a calorimeter (AC600 manufactured by LECO. Co., USA) were used.

LHV(kcal/kg)=HHV(kcal/kg)−600×[(9h+w)/100] [Equation 1]

Here, HHV is a higher heating value, h is a hydrogen content in percent (%), and w is a water content in percent (%) of a test sample.

Equation 1 is an equation for deriving a lower heating value (LHV).

As calculated by Equation 1, the solid fire starter prepared using a porous plant tissue was found to have an LHV of 3,540 kcal/kg, which indicates that the solid fire starter of Example 1 exhibits a higher heating value than conventional lignum-based solid fuels which have an LHV of 3,400 kcal/kg on average.

### Experimental Example 3: Evaluation of Ignition Time of Solid Fire Starter

In order to evaluate an ignition time thereof as a solid fire starter, the solid fire starter of Example 1 was directly ignited, and a combustion time thereof was measured.

Here, a total of six solid fire starters having a length of 14 to 16 cm, a diameter of 2.2 to 2.4 cm, and a weight of 25 to 26 g on average were provided and ignited.

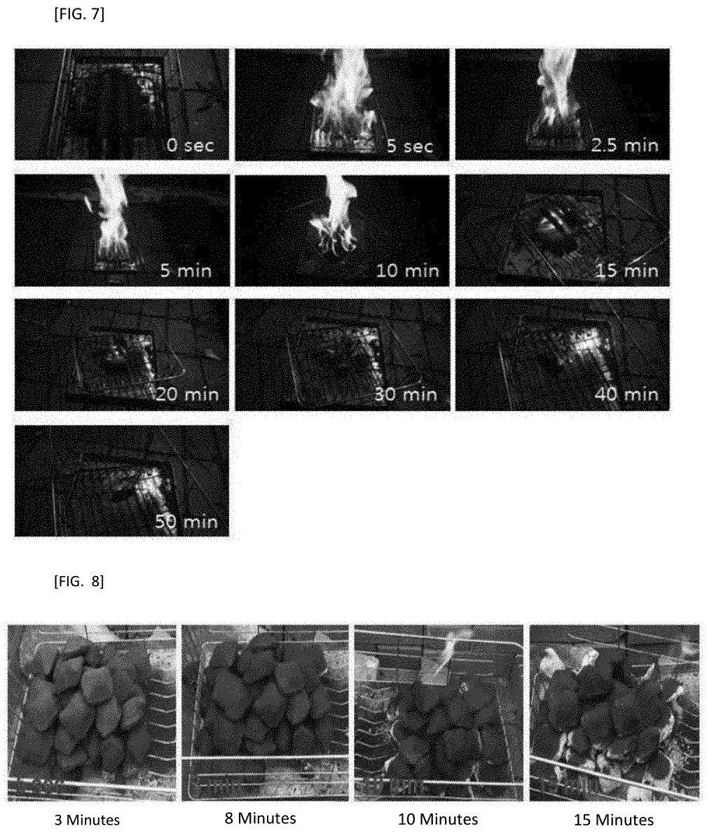

FIG. 7 shows photographic images illustrating the evaluation of the ignition of a solid fire starter prepared using a corncob according to one exemplary embodiment of the present invention.

Referring to FIG. 7, although the solid fire starter was combusted in such a manner that the flame was maintained for 10 minutes following the first ignition, harmful fumes were not emitted at all, and the combustion was continued for 40 minutes or more while turning the solid fire starter into charcoal, and therefore, it was confirmed that the solid fire starter had an effective combustion time as a solid fire starter.

Meanwhile, in order to evaluate an ignition efficiency thereof as a solid fire starter, a total of four solid fire starters were provided and used for igniting 1 kg of black charcoal for roasting.

Referring to FIG. 8, when the solid fire starter was ignited, the flame was maintained for 10 minutes while not generating any smoke, and at 15 minutes after ignition, it was found that the entire black charcoal for roasting was ignited.

Therefore, the solid fire starter is usable for the ignition of a solid fuel and, advantageously, has the ability to ignite a large amount of a solid fuel.

According to the present invention, since corncobs which are discarded due to a low utilization thereof can be utilized as a solid fire starter, the utilization of an annually increasing crop-derived waste product can be dramatically increased.

In addition, since a manufacturing process thereof is very simple compared to that of a conventional lignum-based fire starter and does not require a high-temperature treatment to be carried out, process efficiency thereof is very high, and manufacturing costs can be greatly reduced.

In addition, the solid fire starter has high ignition efficiency such that it can be ignited in less time than solid fuels consisting of lignum or coal, generates a significantly reduced amount of fumes during combustion thereof and thus is environmentally friendly, and has a very high heating value relative to the weight of a solid fuel due to having the ability to completely combust and thus is very highly efficient as a solid fire starter.

In addition, due to having high ignition efficiency, the solid fire starter can facilitate the ignition of a solid fuel even when mixed with a large amount of the solid fuel.

While the solid fire starter prepared using a corncob according to the present invention has been described by way of specific exemplary embodiments hereinabove, it is obvious that the embodiments can be variously modified without departing from the scope of the present invention.

Therefore, the scope of the present invention should be defined by the appended claims and equivalents thereof and not limited by the above-described embodiments.

In other words, the above-described embodiments should be understood in all respects as being illustrative and not restrictive, and it should be construed that the scope of the present invention is defined by the appended claims rather than by the detailed description and that all changes or modifications derived from the meaning and scope of the claims and equivalent concepts thereof are encompassed in the scope of the present invention.

What is claimed is:

1. A solid fire starter prepared using a porous plant tissue, the solid fire starter comprising: a pith portion which includes a porous tissue infiltrated with a heating agent; a woody ring portion which surrounds an outer circumferential surface of the pith portion and maintains the rigidity of a body of the solid fire starter; and a chaff portion which extends from the woody ring portion and includes an amorphous mane-like shell formed thereon.

2. The solid fire starter of claim 1, wherein the porous tissue is derived from any one corn part selected from the group consisting of a corncob and a corn stalk.

3. The solid fire starter of claim 1, wherein the heating agent is any one of C1-C4 alcohols.

4. The solid fire starter of claim 3, wherein the heating agent has a concentration of 95% or more in the case of ethanol.

5. The solid fire starter of claim 1, wherein the solid fire starter has a lower heating value of 3,540 kcal/kg or more.

6. A method of preparing a solid fire starter using a corncob, the method comprising:
(a) providing a fuel body and an immersion bath;
(b) filling the immersion bath with a heating agent and immersing the fuel body therein;
(c) sealing the immersion bath and then allowing the heating agent to infiltrate into the fuel body using a vacuum pump; and
(d) centrifuging the fuel body infiltrated with the heating agent, thereby allowing a heating agent residue on a surface of the fuel body to be removed.

7. The method of claim 6, wherein, in the (a), the fuel body is any one corn part selected from the group consisting of a corncob and a corn stalk and includes a porous tissue.

8. The method of claim 7, wherein the fuel body has a water content of 10% to 15% after removal of fruits and natural drying.

9. The method of claim 6, wherein, in the (b), the heating agent is any one of C1 C4 alcohols.

10. The method of claim 9, wherein the heating agent has a concentration of 95% or more in the case of ethanol.

11. The method of claim 6, wherein, in the (c), the immersion bath is sealed and a negative pressure of 100 kPa/1 kg to 3 kPa/1 kg is maintained for 30 minutes to 60 minutes using a vacuum pump, allowing the heating agent to infiltrate into the fuel body.

12. The method of claim 6, wherein, in the (d), the fuel body is centrifuged at 1,000 rpm to 3,000 rpm for one minute to five minutes, allowing a heating agent residue to be removed from a surface of the fuel body.
